(19) United States
(12) Patent Application Publication
(10) Pub. No.: US 2008/0118812 A1
(43) Pub. Date: May 22, 2008

(54) FUEL CELL STACK AND FUEL CELL DEVICE INCLUDING THE SAME

(75) Inventors: Akira Kawakami, Kitakyushu-shi (JP); Naoki Watanabe, Kitakyushu-shi (JP)

Correspondence Address: BROOKS KUSHMAN P.C., 1000 TOWN CENTER, TWENTY-SECOND FLOOR, SOUTHFIELD, MI, 48075, US

(73) Assignee: TOTO LTD., Fukuoka (JP)

(21) Appl. No.: 11/855,494

(22) Filed: Sep. 14, 2007

(30) Foreign Application Priority Data
Sep. 15, 2006 (JP) 2006-251528

(51) Int. Cl. H01M 8/02; H01M 8/24; H01M 8/10

(52) U.S. Cl. 429/38; 429/31; 429/32

(57) ABSTRACT

The present invention relates to a fuel cell stack incorporated in a fuel cell device and a fuel cell device including such a fuel cell stack. The fuel cell stack (4) according to the present invention has a plurality of tubular fuel cell bodies (6-10) arranged laterally relative to a longitudinal direction of the fuel cell bodies and electrically insulating support plates (12, 14) fixed to respective opposite ends (6a, 6b) of the plurality of the fuel cell bodies (6-10). Each of the fuel cell bodies (6-10) has an inner electrode layer (16), an outer electrode layer (20) and an electrolyte layer (18) disposed between the inner and outer electrode layers (16, 20). Each of the fuel cell bodies (6-10) also has, at one end thereof, an inner electrode exposed periphery (16a) where the inner electrode layer (16) is exposed out of the electrolyte layer (18) and the outer electrode layer (20). The fuel cell stack (4) further has connections (15) disposed at each of the support plates (12, 14) to electrically connect the fuel cell bodies (6-10) in an arbitrary combination.

### FIELD OF THE INVENTION

The present invention relates to a fuel cell stack used in a solid-oxide fuel cell (SOFC) and a fuel cell device including such a fuel cell stack, and more specifically, to a fuel cell stack having a tubular fuel cell and a fuel cell device including such a fuel cell stack.

### BACKGROUND OF THE INVENTION

Conventionally, a fuel cell stack having a tubular fuel cell has been known as shown, for example, in FIGS. 5-7 in Japanese Patent Laid-open Publication No. 2002-289249 and in FIGS. 1 and 6 in Japanese Patent Laid-open Publication No. 5-101842. Now, referring to FIGS. 14-16, an example of a conventional fuel cell stack described in the Japanese Patent Laid-open Publication No. 2002-289249 will be explained. FIG. 14 is a schematically perspective view of a conventional fuel cell stack, FIG. 15 is a schematically perspective view of another conventional fuel cell stack, and FIG. 16 is a perspective view of a conventional fuel cell stack assembly.

As shown in FIG. 14, a fuel cell stack 100 described in the Japanese Patent Laid-open Publication No. 2002-289249 has a structure in which a plurality of cylindrical fuel cells 102 are laterally arranged and opposite ends thereof are supported by respective metallic plates 104. In the fuel cell stack 100, the fuel cells 102 are electrically connected to each other in parallel.

Further, as shown in FIG. 15, another fuel cell stack 110 described in the above-stated Japanese Patent laid-open Publication No. 2002-289249 has fuel cell bodies 114 in which fuel cells 112 are coupled to each other in a longitudinal direction and electrically connected to each other in a series.

Further, as shown in FIG. 16, in order to electrically connect fuel cells 122 in a series, a fuel cell stack assembly 120 described in the above-stated Japanese Patent Laid-open Publication No. 2002-289249 has a section 126 in which a plurality of fuel cell stacks 124 are longitudinally coupled to each other and a section 130 in which two fuel cell stacks 124 are arranged laterally, reversed in the longitudinal direction, and coupled to each other with a metallic plate 128.

Further, Japanese Patent Laid-open Publication No. 5-101842 describes a hollow hexagonal fuel cell, at an end of which an inner electrode is longitudinally exposed.

A voltage which can be generated by a single fuel cell is constant regardless of a size thereof. Thus, to obtain a high voltage, it is required that fuel cells be electrically connected to each other in a series. On the other hand, to obtain a large current, for example, fuel cells are connected to each other in parallel. A number of fuel cells connected to each other in a series or in parallel varies depending on the use thereof.

In the above-stated fuel cell stacks 100, 110, 124 described in Japanese Patent Laid-open Publication No. 2002-289249 define a unit consisting of a plurality of fuel cells 102, 112, 122 electrically connected to each other in parallel. Thus, when electrical parallel and series connections of the fuel cells 102, 112, 122 are made, a whole structure of a fuel cell device is limited to the numbers of the fuel cells 102, 112, 122 electrically connected to each other in parallel. That is, in order to electrically connect the fuel cells 102, 112, 122 to each other in a series, two approaches are used; in the first approach as shown in FIG. 15, a plurality of fuel cells 112 are electrically connected to each other in a series to form a combination unit and such combination units are electrically connected to each other in parallel to form a fuel cell stack 110, and, in the second approach as shown in FIG. 16, the fuel cell stacks 100, 110, 124 are electrically connected to each other in a series. These approaches are suitable to a large-size fuel cell device having many fuel cells electrically connected to each other in parallel, but not suitable to a small-size fuel cell device.

It is therefore an object of the present invention is to provide a fuel cell stack in which any electrically parallel and series connections of fuel cell bodies can be easily made, and a fuel cell device including such a fuel cell stack.

### SUMMARY OF THE INVENTION

In order to achieve the above-stated object, a fuel cell stack incorporated in a fuel cell device according to the present invention comprises a plurality of tubular fuel cell bodies arranged laterally relative to a longitudinal direction of the fuel cell bodies; and electrically insulating support plates fixed to respective opposite ends of the plurality of the fuel cell bodies; wherein each of the fuel cell bodies has a tubular outer electrode layer, a tubular inner electrode layer and a tubular electrolyte layer disposed between the inner and outer electrode layers; wherein each of the fuel cell bodies has, at one end thereof, an inner electrode exposed periphery where the inner electrode layer is exposed out of the electrolyte layer and the outer electrode layer; wherein each of the fuel cell bodies has, on a peripheral surface at the one end thereof, an inner electrode peripheral surface electrically communicating with the inner electrode layer via the inner electrode exposed periphery, and, on a peripheral surface at the other end thereof, an outer electrode peripheral surface electrically communicating with the outer electrode layer; and further comprises connections disposed at each of the support plates to electrically connect the inner electrode peripheral surface(s) to the outer electrode peripheral surface(s) of the fuel cell bodies arranged adjacent to each other in an arbitrary combination.

In this fuel cell stack according to the present invention, since the support plates are insulated, the fuel cell bodies can be electrically connected to each other in parallel by electrically connecting the inner electrode peripheral surfaces of the fuel cells adjacent to each other and by electrically connecting the outer electrode peripheral surfaces thereof. Further, by electrically connecting the inner electrode peripheral surface to the outer electrode peripheral surface of the fuel cell bodies adjacent to each other, the fuel cell bodies can be electrically connected to each other in a series. Thus, any parallel and series connections of the fuel cell bodies can be achieved while a distance between the support plates is kept constant.

Further, since electricity at the inner electrode layer is taken out via the inner electrode peripheral surface (namely, the peripheral surface) of the fuel cell body, a way to take up electricity from the inner electrode layer can be standardized in such a way so as to take out electricity from the outer electrode layer so that electrically parallel and series connections between the fuel cell bodies become easy.

In an embodiment of the fuel cell stack, preferably, the connections have conductive sealers for sealingly fixing the ends of the fuel cell body to the support plate.

In this fuel cell stack, gas sealing between the opposed sides of the support plate can be achieved by the support plate and the sealer. Further, electricity generated at the inner electrode layer is taken out through the inner electrode peripheral surface and the sealer, the inner electrode peripheral surface being exposed to outside of the peripheral surface of the fuel cell, while electricity generated at the outer electrode layer is taken out through the outer electrode peripheral surface and the sealer.

In this embodiment, the sealer has a function of fixing the fuel cell body and the support plate to each other and a function of taking out electricity through the inner electrode and the outer electrode of the fuel cell body. Thus, in both electrical series and parallel connections, a structure of the fuel cell stack become simple so that manufacturing of the fuel cell stack becomes easy. Further, since the conductive sealer has a good adhesion, interface contact resistance becomes small and thus, in both electrical series and parallel connections, a fuel cell stack with good electrical power generating performance and good reliability can be obtained.

Further, in an embodiment of the fuel cell stack, preferably, at least some of the fuel cell bodies are electrically connected in a series.

Further, in an embodiment of the fuel cell stack, preferably, each of the fuel cell bodies is defined by a single fuel cell or a plurality of fuel cells longitudinally coupled to each other and electrically connected to each other in a series.

Further, in an embodiment of the fuel cell stack, the inner electrode peripheral surface may be defined by the inner electrode exposed periphery or an inner electrode collecting layer disposed outside thereof. Further, the outer electrode peripheral surface may be defined by the outer electrode layer or an outer electrode collecting layer disposed outside thereof.

Further, in order to achieve the above-stated object, a fuel cell device according to the present invention comprises the above-stated fuel cell stack.

As explained above, the fuel cell stack and the fuel cell device including such a fuel cell stack according to the present invention can easily make any electrical parallel and series connections of the fuel cell bodies.

### BRIEF DESCRIPTION OF THE DRAWINGS

FIG. 1 is a schematically plan view of a fuel cell device according to a first embodiment of the present invention,

FIG. 2 is an enlarged cross-sectional view of one end of a fuel cell,

FIG. 3 is an enlarged cross-sectional view of the other end of the fuel cell,

FIG. 4 is a cross-sectional view of a first variant of the one end of the fuel cell,

FIG. 5 is a cross-sectional view of a second variant of the one end of the fuel cell,

FIG. 6 is a cross-sectional view of a first variant of the other end of the fuel cell,

FIG. 7 is a cross-sectional view of a second variant of the other end of the fuel cell,

FIG. 8 is a cross-sectional view of a third variant of the other end of the fuel cell,

FIG. 9 is a perspective view of a first variant of a fuel cell stack of the present invention,

FIG. 10 is a perspective view of a second variant of a fuel cell stack of the present invention,

FIG. 11 is a cross-sectional view of one end of a second embodiment of the present invention,

FIG. 12 is a cross-sectional view of the other end of the second embodiment of the present invention,

FIG. 13 is a schematically plan view of a fuel cell device according to a third embodiment of the present invention,

FIG. 14 is a schematically perspective view of a fuel cell stack in prior art,

FIG. 15 is a schematically perspective view of a fuel cell stack in prior art, and

FIG. 16 is a schematically perspective view of a fuel cell stack-assembly in prior art.

### DETAILED DESCRIPTION OF THE PREFERRED EMBODIMENTS

Now, referring to Figures, embodiments of a fuel cell device according to the present invention will be explained in detail.

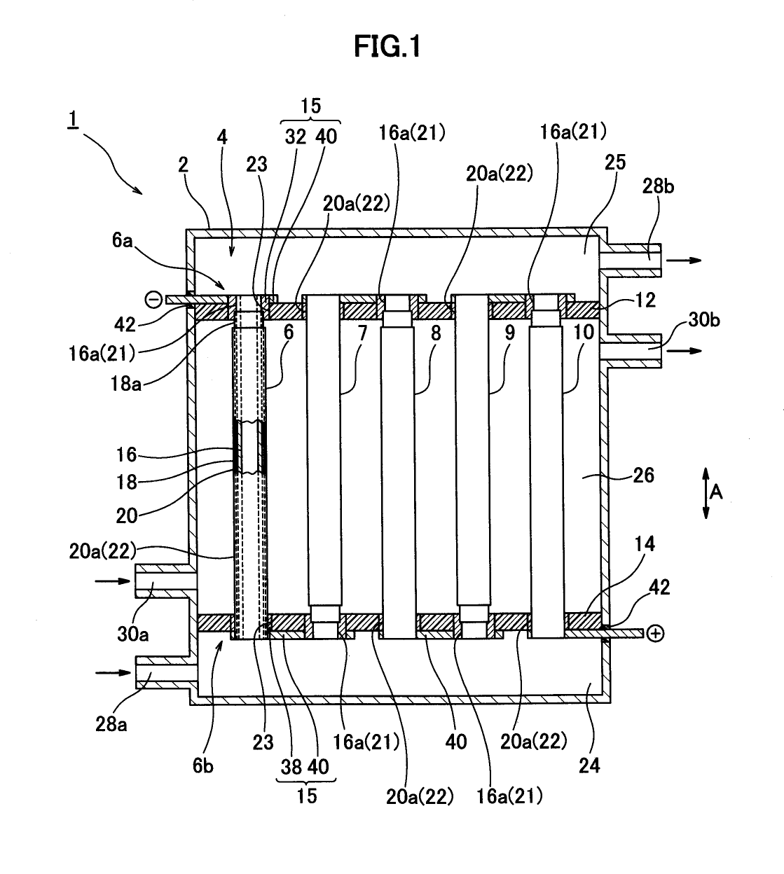

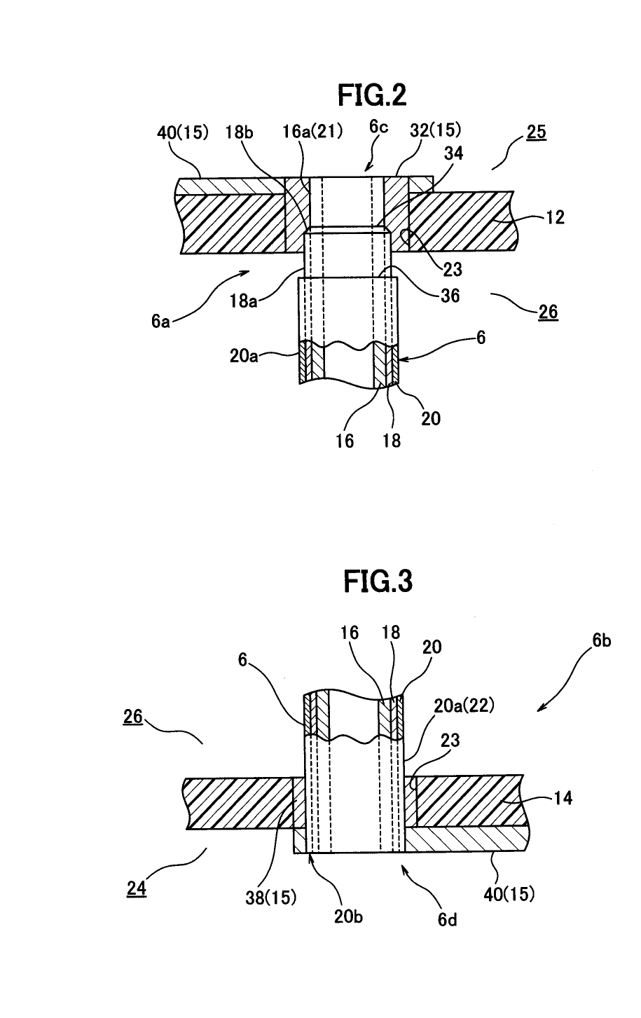

First, referring to FIGS. 1-3, a first embodiment of a fuel cell device according to the present invention will be explained. FIG. 1 is a schematically plan view of a fuel cell device according to the first embodiment of the present invention. FIG. 2 is an enlarged view of one end of a fuel cell and FIG. 3 is an enlarged view of the other end thereof.

As shown in FIG. 1, a fuel cell device 1 which is the first embodiment of the present invention has a case 2 and a fuel cell stack 4 according to the present invention disposed in the case 2.

The fuel cell stack 4 has five tubular fuel cell bodies having respective outer peripheral surfaces and arranged laterally relative to a longitudinal direction A of the fuel cell bodies, first and second support plates 12, 14 through which ends of the fuel cell bodies extend and to which the ends thereof are fixed, and connections 15 electrically connecting the fuel cell bodies to each other. In this embodiment, the five fuel cell bodies are defined by respective fuel cells 6, 7, 8, 9, 10, and these fuel cells 6-10 are cylindrical. Hereinafter, the fuel cell 6 shown on the leftmost side in FIG. 1 is focused upon and will be explained.

The fuel cell 6 has a cylindrical inner electrode layer 16, a cylindrical outer electrode layer 20, and a cylindrical electrolyte layer 18 disposed between these electrode layers 16, 20. The fuel cell 6 has, at one end 6a thereof, an inner electrode exposed periphery 16a where the inner electrode layer 16 is exposed out of the electrolyte layer 18 and the outer electrode layer 20, and an electrolyte exposed periphery 18a where the electrolyte layer 18 is exposed out of the outer electrode layer 20, the inner electrode exposed periphery 16a and the electrolyte exposed periphery 18a defining portions of the outer peripheral surface of the fuel cell 6. The remaining portion of the outer peripheral surface of the fuel cell 6 including the other end 6b thereof is defined by an outer electrode exposed periphery 20a where the outer electrode layer 20 is exposed. In this embodiment, the inner electrode exposed periphery 16a also defines an inner electrode peripheral surface 21 electrically communicating with the inner electrode layer 16, and the outer electrode exposed periphery 20a also defines an outer electrode peripheral surface 22 electrically communicating with the outer electrode layer 20.

The inner electrode layer 16 is made of, for example, at least one of a mixture of Ni and zirconia doped with at least one of Ca and rare-earth elements such as Y and Sc; mixture of Ni and ceria doped with at least one of rare-earth elements; and a mixture Ni and lanthanum-gallate doped with at least one of Sr, Mg, Co, Fe and Cu. The electrolyte layer 18 is made of, for example, at least one of zirconia doped with at least one of rare-earth elements such as Y and Sc; ceria doped with at least one of rare-earth elements; and lanthanum-gallate doped with at least one of Sr and Mg. The outer electrode layer 20 is made of, for example, at least one of lanthanum-manganite doped with at least one of Sr and Ca; lanthanum-ferrite doped with at least one of Sr, Co, Ni and Cu; samarium-cobalt doped with at least one of Sr, Fe, Ni, Cu; and silver. In this case, the inner electrode layer 16 is a fuel electrode, while the outer electrode layer 20 is an air electrode. A thickness of the inner electrode layer 16 is, for example, 1 mm, that of the electrolyte layer 18 is, for example, 30 μm, and that of the outer electrode layer 20 is, for example, 30 μm.

The first and second support plates 12, 14 are electric insulating, have respective apertures through which the fuel cell 6 extends, and are sealingly attached to the case 2. Thus, the case 2 is divided into first and second chambers 24, 25 which are located on the respective opposite sides of the fuel cell 6 in the longitudinal direction A and through which gas acting on the inner electrode layer 16 flows, and a third chamber 26 which is located in the middle of the fuel cell 6 in the longitudinal direction A and though which gas acting on the outer electrode layer 20 flows. The first chamber 24 has a gas input port 28a and the second chamber 25 has a gas output port 28b. The third chamber 26 has a gas input port 30a and a gas output port 30b. The support plates 12, 14 are made of, for example, heat-resistant ceramics. Specifically, alumina, zirconia, spinel, forsterite, magnesia, or titania are preferably employed for such ceramics. The material of the support plates 12, 14 is more preferably one whose coefficient of thermal expansion is close to that of components defining the fuel cell stack. Further, gas acting on the inner electrode 16 is, for example, gas reformed from hydrogen or hydrocarbon fuel, while gas acting on the outer electrode 20 is, for example, air.

One end 6a of the fuel cell 6 and the first support plate 12 are sealingly fixed to each other with a first conductive sealer 32. The first conductive sealer 32 can function as a part of the connections 15, as explained later.

As shown in FIG. 2, the inner electrode exposed periphery 16a and the electrolyte exposed periphery 18a extend over the entire circumference of the fuel cell 6 and are adjacent to each other in the longitudinal direction A. Further, the inner electrode exposed periphery 16a is located at a tip 6c of the fuel cell 6 and partially extends beyond the first support plate 12. A boundary 34 between the inner electrode exposed periphery 16a and the electrolyte exposed periphery 18a is located inside of the first support plate 12, while a boundary 36 between the electrolyte exposed periphery 18a and the outer electrode exposed periphery 20a is located in the third chamber 26. The first sealer 32 is disposed to divide a region for gas acting on the inner electrode layer 16, i.e., the second chamber 25, from a region for gas acting on the outer electrode layer 20, i.e., the third chamber 26.

The first sealer 32, which also functions as a part of the connections 15, extends from the inner electrode exposed periphery 16a to the electrode exposed periphery 18a over the entire circumference of the fuel cell 6, and is spaced from the outer electrode layer 20 via the electrolyte exposed periphery 18a. Further, the electrolyte exposed periphery 18a has a taper portion 18b which becomes thin toward the inner electrode exposed periphery 16a. The first sealer 32 is, for example, silver, a mixture of silver and glass, or wax including silver, gold, nickel, copper or titan.

Further, the other end 6b of the fuel cell 6 and the second support plate 14 are sealingly fixed to each other with a second conductive sealer 38. The second sealer 38 can function as a part of the connections 15, as explained later.

As shown in FIG. 3, the second sealer 38 is disposed to substantially divide a region for gas acting on the inner electrode layer 16, i.e., the first chamber 24, from a region for gas acting on the outer electrode layer 20, i.e., the third chamber 26. Specifically, only an end surface 20b of the outer electrode layer 20 is exposed to the first chamber 24.

The second sealer 38, which also functions as a part of the connection 15, extends on the outer electrode exposed periphery 20a. The outer electrode exposed periphery 20a partially extends beyond the second support plate 14. The second sealer 38 is, for example, silver, a mixture of silver and glass or wax including silver, gold, nickel, copper or titan.

Each of the other fuel cells 7-10 has a structure similar to that of the fuel cell 6. Hereinafter, components of the fuel cells 7-10 are explained in such a way that they are indicated by the same reference numbers as those indicating the corresponding components of the fuel cell 6

As shown in FIG. 1, the five fuel cells 6-10 are alternately arranged so that, regarding two adjacent fuel cells thereof, the inner electrode peripheral surface, namely, the inner electrode exposed periphery 16a at the one end 6a of the one fuel cell, is adjacent to the outer electrode peripheral surface, namely, the outer electrode exposed periphery 20a at the other end 6b of the other fuel cell. Thus, regarding the second and fourth fuel cells 7, 9, the one ends 6a thereof are fixed to the second support plate 14, while the other ends 6b thereof are fixed to the first support plate 12.

The connections 15 further have connecting members 40 for electrically connecting the inner electrode exposed periphery 16a to the outer electrode exposed periphery 20a adjacent thereto, or for electrically connecting the inner electrode exposed periphery 16a or the outer electrode exposed periphery 20a to the exterior. In this embodiment, the connecting members 40 are disposed on a first-chamber 24 side of the second support plate 14 or a second-chamber 25 side of the first support plate 12. Further, in this embodiment, the five fuel cells are electrically connected to each other in a series. The connecting members 40 respectively electrically connected to the inner electrode exposed periphery 16a of the fuel cell 6 and the outer electrode exposed periphery 20a of the fuel cell 10 extend through the case 2 to pick up electricity therefrom outside of the case. The case 2 is made of heat-resistant metal, for example, stainless steel, nickel base alloy and chrome base alloy, and an insulating member 42 is disposed between the case 2 and the connecting members 40. The connecting members 40 are made of heat-resistant metal such as stainless steel, nickel base alloy and chrome base alloy, or conductive ceramic material such as lanthanum chromite. A shape of each of the connecting members 40 may be appropriately one of plate, wire, mesh, film and so on. In view of the simplification of manufacturing processes and cost reduction, the connecting members 40 are preferably conductive films which are pre-formed on the support plates and made of, for example, silver, nickel or copper with a thickness within 1-500 μm.

Next, an operation of the fuel cell device according to the present invention will be explained.

Gas (fuel gas) acting on the inner electrode layer 16 enters the first chamber 24 through the input port 28a thereof, then enters the second chamber 25 through the tubular fuel cells 6-10 and exits the second chamber 25 through the output port 28b thereof. Further, gas (air) acting on the outer electrode layer 20 enters the third chamber through the input port 30a thereof and exits the same through the output port 30b thereof. Thus, the fuel cell device 1 is activated. Electricity from the inner electrodes 16 can be taken out via the first sealer 32 and the connecting member 40, while electricity from the outer electrodes 20 can be taken out via the second sealer 38 and the connecting member 40.

Since there is no member for taking out electricity from the outer electrode 20 inside of the third chamber 26, resistance against flow of gas acting on the outer electrode 20 can be reduced.

When the gas acting on the inner electrode layer 16 is fuel gas such as gas reformed from hydrogen or hydrocarbon fuel, disposing the connecting members 40 on the first-chamber 24 side of the second support plate 14 or the second-chamber 25 side of the first support plates 12 allows oxidation degradation of the connecting members to be restricted.

Further, the sealers 32, 37 have a function of sealingly fixing the fuel cells 6-10 to the support plates 12, 14 and a function of taking out electricity from the inner electrode 16 or the outer electrode 20 of the fuel cell. Thus, a structure of the fuel cell stack 4 is simple.

Further, since electricity from the inner electrode 16 is taken out through the inner electrode exposed periphery 16a, flow of gas acting on the inner electrode 15 is not obstructed. Further, since a contact area between the sealer 32 and the inner electrode peripheral surface 16a can become larger, contact resistance therebetween can be reduced. Especially, it is advantageous to use fuel cells each having a diameter within 1-10 mm.

Next, an example of a way of manufacturing a fuel cell device according to the present invention will be explained.

First, tubular fuel cells are formed. Specifically, the tubular inner electrode layer 16 is formed, then, the electrolyte layer 18 is formed around the inner electrode layer 16 so that the end of the inner electrode layer 16 is exposed, and then the outer electrode layer 20 is formed around the electrolyte layer 18 so that the end of the electrolyte layer 18 is exposed. After that, the taper portion 18b may be formed at the end of the electrolyte layer 18.

Next, the conductive film defining the connections 40 is formed on the support plates 12, 14. In view of the simplification of manufacturing processes and cost reduction, the conductive film is preferably pre-formed on the support plates 12, 14 by a wet process, for example, a screen print process, slurry coating process or sheet adhering process.

Next, the fuel cells 6-10 are disposed in the predetermined directions, the ends of the fuel cells 6-10 are passed through the first and second plates 12, 14, and then the fuel cells 6-10 and the first and second support plates 12, 14 are sealingly fixed to each other with the first and second sealers 32, 38. At this point, the sealers 32, 38 are disposed so as to make sure to contact both the fuel cells 6-10 and the conductive film formed on the support plates 12, 14. Thus, the fuel cell stack 4 is formed.

Next, the fuel cell stack 4 is fixed into the case 2 and thus the fuel cell device 1 is formed.

Since the inner electrode exposed periphery 16a is employed and the sealers 32, 38 are used, the manufacturing process of the fuel cell stack 4 and the fuel cell device 1 becomes easy. Specially, it is advantageous to use the fuel cells 6-10 each having a diameter within 1-10 mm.

Further, when the sealer 32 is disposed or filled between the support plate 12 and the fuel cells 6-10, the taper portion 18b of the electrolyte layer 18 can prevent degradation of gas-sealing performance of the sealer 32 due to bubbles and so on remaining between the inner electrode exposed periphery 16a and the electrolyte exposed periphery 18a. This improves a yield ratio and easily allows a stable manufacturing process.

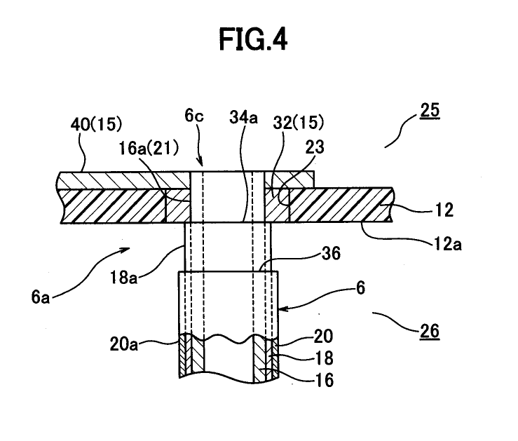

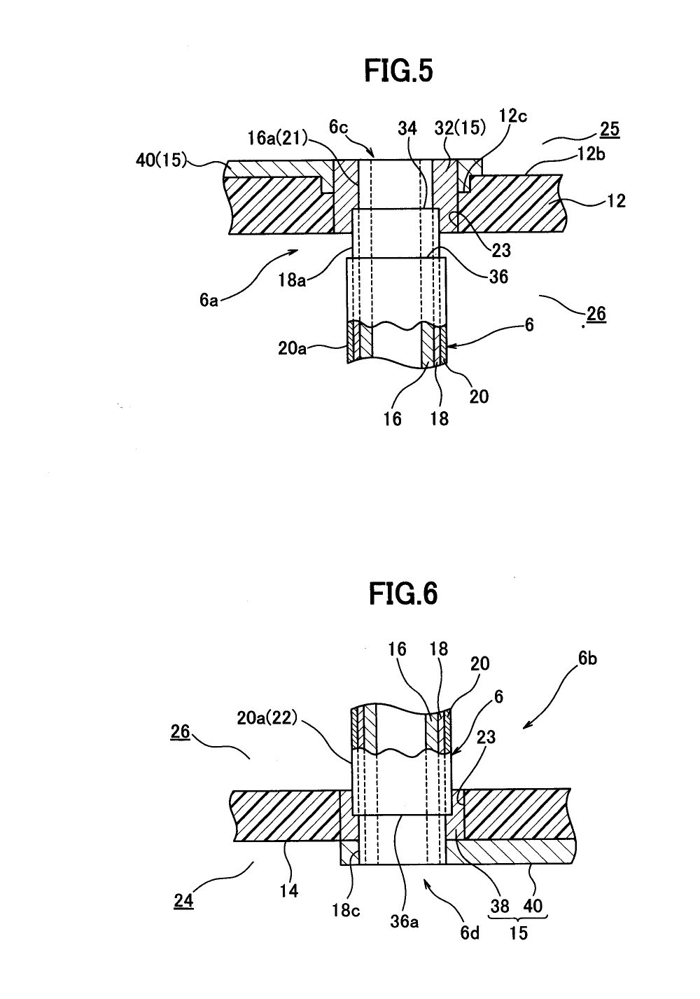

Next, referring to FIGS. 4 and 5, variants of the one end 6a of the fuel cell 6 will be explained.

FIG. 4 is a cross-sectional view of a first variant of the one end of the fuel cell. As shown in FIG. 4, the boundary 34a between the inner electrode exposed periphery 16a and the electrolyte exposed periphery 18a may be located in the same plane as that including the surface 12a of the first support plate 12 on the third-chamber 26 side thereof, and the sealer 32 is disposed only around the inner electrode exposed periphery 16a. Further, the connections 40 may be disposed so as to contact the inner electrode exposed periphery 16a.

FIG. 5 is a cross-sectional view of a second variant of the one end of the fuel cell. As shown in FIG. 5, a recess 12c may be provided on the surface of the first support plate 12 on the second-chamber 25 side thereof so that a contact area between the connections 40 and the sealer 32 become large.

Next, referring to FIGS. 6-8, variants of the other end 6b of the fuel cell 6 will be explained.

FIG. 6 is a cross-sectional view of a first variant of the other end of the fuel cell. As shown in FIG. 6, at a tip 6d of the other end 6b of the fuel cell 6, the electrolyte layer 18 may be exposed to the peripheral surface of the fuel cell 6 to form a second electrolyte exposed periphery 18c, and a boundary 36a between the outer electrode exposed periphery 20a and the second electrolyte exposed periphery 18c may be located inside of the second support plate 14. Thus, a region for gas acting on the inner electrode layer 16, i.e., the first chamber 24, can be divided from a region for gas acting on the outer electrode layer 20, i.e. the third chamber.

Further, the outer electrode 20 can prevent from degradation caused by contacting gas acting on the inner electrode 16.

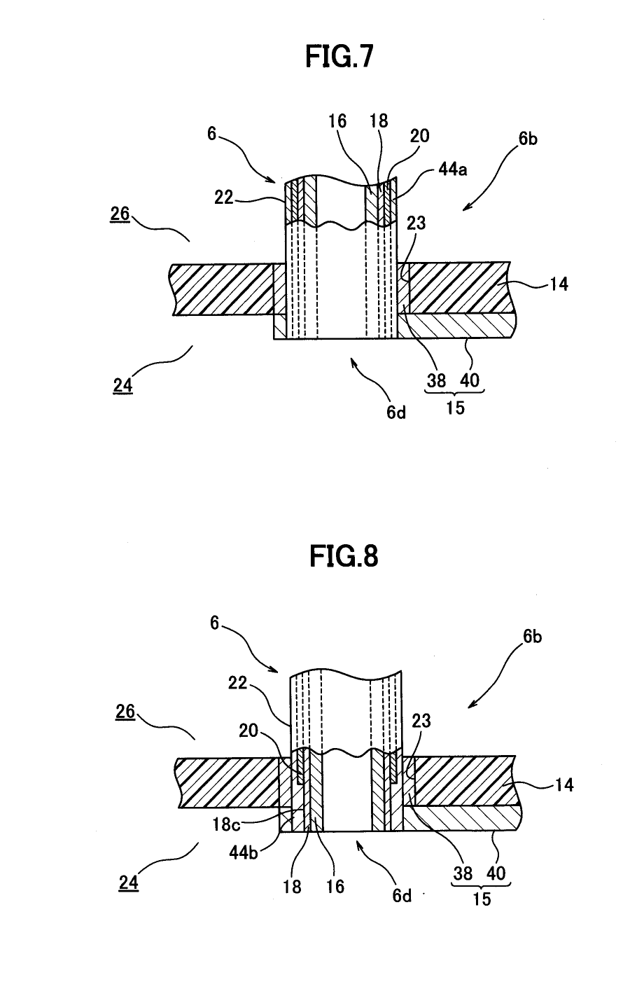

FIG. 7 is a cross-sectional view of a second variant of the other end of the fuel cell. As shown in FIG. 7, an outer electrode collecting layer 44a may be disposed entirely or partially around the outer electrode 20 of the fuel cell 6. In this variant, the outer electrode peripheral surface 22 electrically connected to the outer electrode 20 is defined by the outer electrode collecting layer 44a. The outer electrode collecting layer 44a is, for example, a porous conductive film containing silver. A thickness of the outer electrode collecting layer 44a is, for example, 10 μm. Further, the outer electrode collecting layer 44a may be formed of wire or mesh of silver or heat-resistant metal. The outer electrode collecting layer 44a serves as an electrical passage when the outer electrode layer 20 is thin so that it does not tend to conduct electricity.

FIG. 8 is a cross-sectional view of a third variant of the other end of the fuel cell. As shown in FIG. 8, at a tip 6d of the other end 6b of the fuel cell 6, the electrolyte layer 18 may be exposed to the peripheral surface of the fuel cell 6 to form a second electrolyte exposed periphery 18b, and then an outer electrode collecting layer 44b may be disposed entirely or partially around the outer electrode 20 and the second electrolyte exposed periphery 18b. In this variant, the outer electrode peripheral surface 22 electrically connected to the outer electrode 20 is defined by the outer electrode collecting layer 44b. A material, a thickness and so on of the outer electrode collecting layer 44b are the same as those of the outer electrode collecting layer 44a of the above-stated second variant. The outer electrode collecting layer 44b can prevent degradation caused by contacting gas acting on the inner electrode 16.

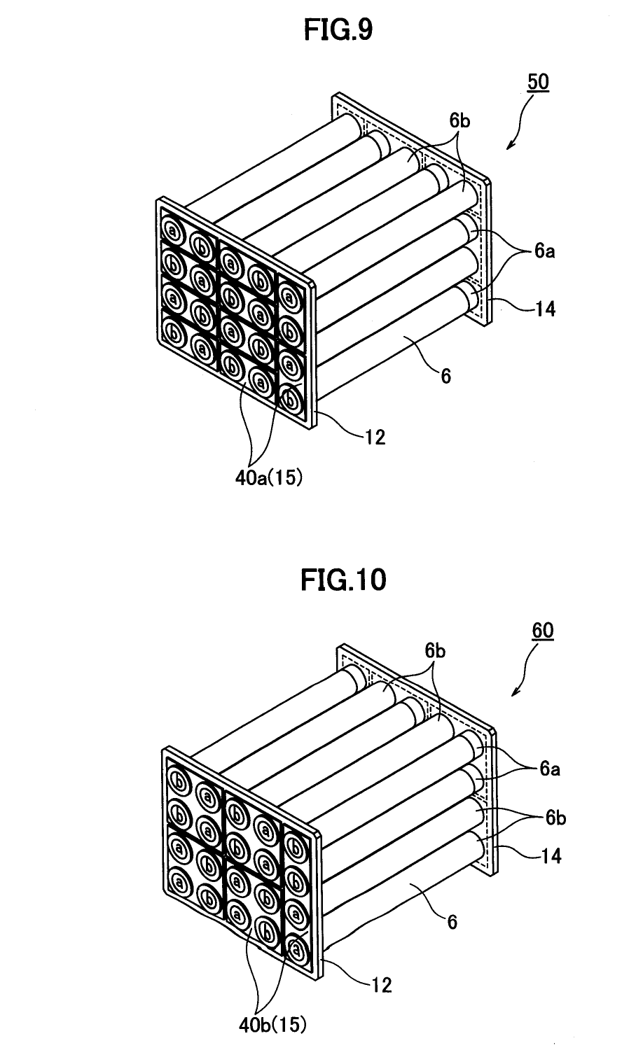

Next, referring to FIG. 9, a first variant of the fuel cell stack according to the present invention will be explained. FIG. 9 is a schematically perspective view of a first variant of the fuel cell stack according to the present invention.

As shown in FIG. 9, in a fuel cell stack 50 which is the first variant of the fuel cell stack according to the present invention, all twenty fuel cells arranged in 5 rows X 4 rows are electrically connected in a series. References “a” and “b” shown in FIG. 9 are for indicating directions of the fuel cells 6; concretely, the reference “a” indicates the one end 6a while the reference “b” indicates the other end 6b.

Next, referring to FIG. 10, a second variant of the fuel cell stack according to the present invention will be explained. FIG. 10 is a schematically perspective view thereof.

As shown in FIG. 10, in a fuel cell stack 60 which is the second variant of the fuel cell according to the present invention, two fuel cells in each of ten sets of two fuel cells in twenty fuel cells 6 arranged 5 rows×4 rows are electrically connected in parallel with the connections 40b and these ten sets of two fuel cells are electrically connected in a series with the connections 40b. Reference letters “a” and “b” shown in FIG. 10 are for indicating directions of the fuel cells 6; concretely, the reference “a” indicates the one end 6a while the reference “b” indicates the other end 6b.

As can be seen from the fuel cell stacks 50, 60, the connections 40a, 40b attached to the support plates 12, 14 make electrical connections between the inner electrode peripheral surface(s) 21 of the one end(s) 6a and the outer electrode peripheral surface(s) 22 of the other end(s) 6b of the fuel cell(s) 6 adjacent to each other in an arbitrary combination.

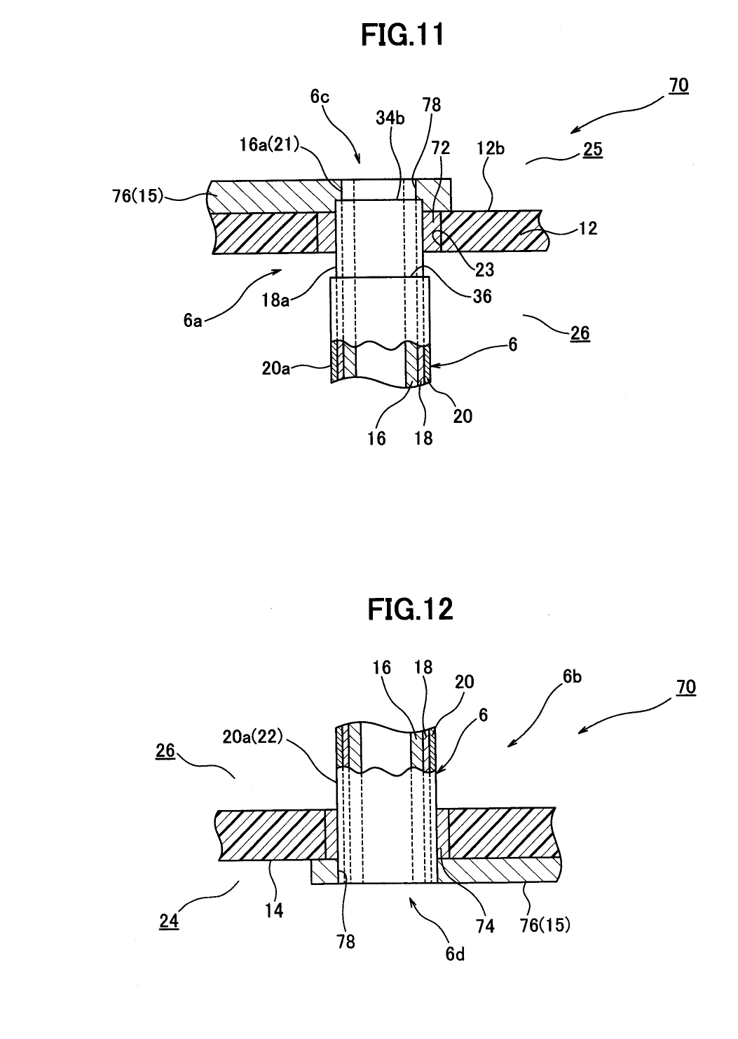

Next, referring to FIGS. 11 and 12, a second embodiment of the fuel cell device according to the present invention will be explained. A fuel cell device 70 according to the second embodiment of the present invention has a structure similar to that of the fuel cell device 1 according to the first embodiment of the present invention except for the connection 5, the first end 6a, the first sealer 32 and the second sealer 40. Thus, only portions of the second embodiment different from the first embodiment will be explained. FIG. 11 is a cross-sectional view of the one end of the fuel cell device according to the second embodiment of the present invention, and FIG. 12 is a cross-sectional view of the other end of the fuel cell device according to the same.

As shown in FIG. 11, the one end 6a of the fuel cell 6 and the first support 12 are sealingly fixed to each other with a first insulating sealer 72. Further, a boundary 34b between the inner electrode exposed periphery 16a and the electrolyte exposed periphery 18a is located inside of the second chamber 25. The first sealer 72 is disposed so that a region for gas acting on the inner electrode 16, i.e., the second chamber 25 is divided from a region for gas acting on the outer electrode layer, i.e., the third chamber 28. The first sealer 72 is, for example, crystallized glass or glass ceramics.

As shown in FIG. 12, the other end 6b of the fuel cell and the second support plate 14 are sealingly fixed to each other with a second sealer 74. The second sealer 74 is disposed so that a region for gas acting on the inner electrode layer 16, i.e., the second chamber 25, is substantially divided from a region for gas acting on the outer electrode layer 20, i.e., the third chamber 26. Specifically, only an end surface 20b of the outer electrode layer is exposed to the first chamber 24. The second sealer 74 is, for example, crystallized glass or glass ceramics.

As shown in FIGS. 11 and 12, in this embodiment, the inner electrode exposed periphery 16a also defines the inner electrode peripheral surface 21 electrically connected to the inner electrode layer 16, and the outer electrode exposed periphery 20a also defines the outer electrode peripheral surface 22 electrically connected to the outer electrode layer 20. The connections 15 have connecting members 76 for electrically connecting the inner electrode peripheral surfaces 21 to the outer electrode peripheral surfaces 22 adjacent thereto, and the connecting members 76 are provided on a surface of the support body 12 on the second-chamber 25 side thereof and on a surface of the support body 14 on the first-chamber 24 side thereof. The connecting member 76 has a contact surface 78 contacting the inner electrode peripheral surface 21 or the outer electrode peripheral surface 22, and may be in a form of a plate or a wire.

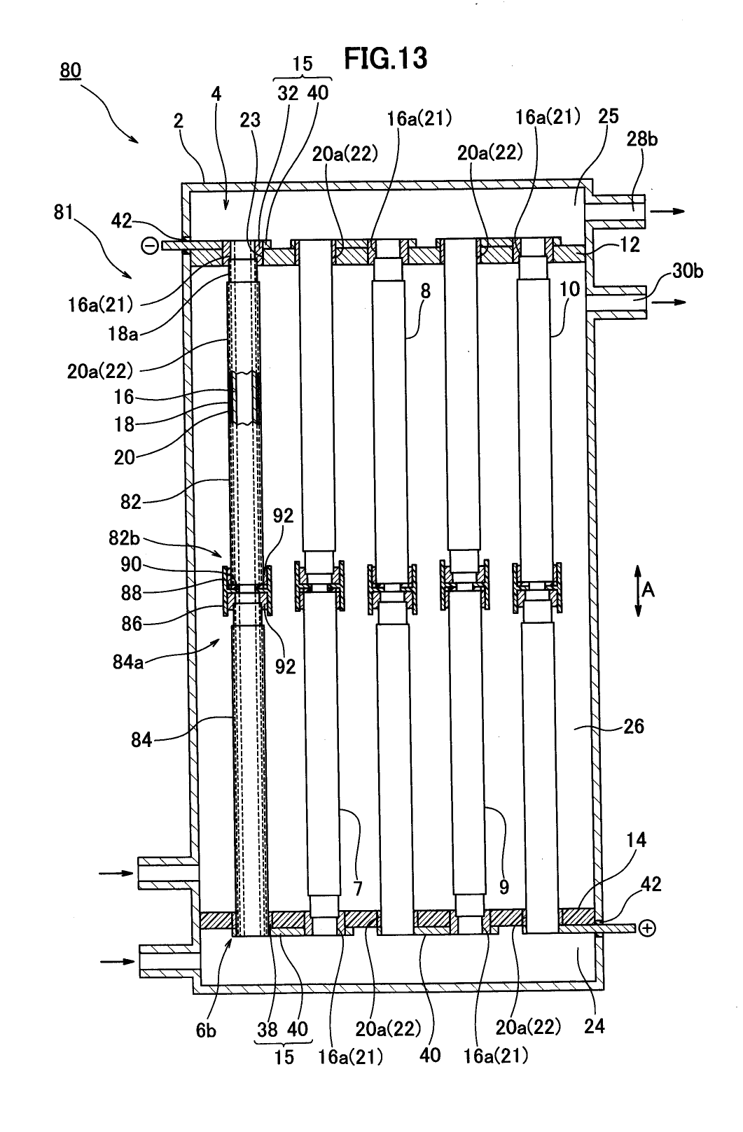

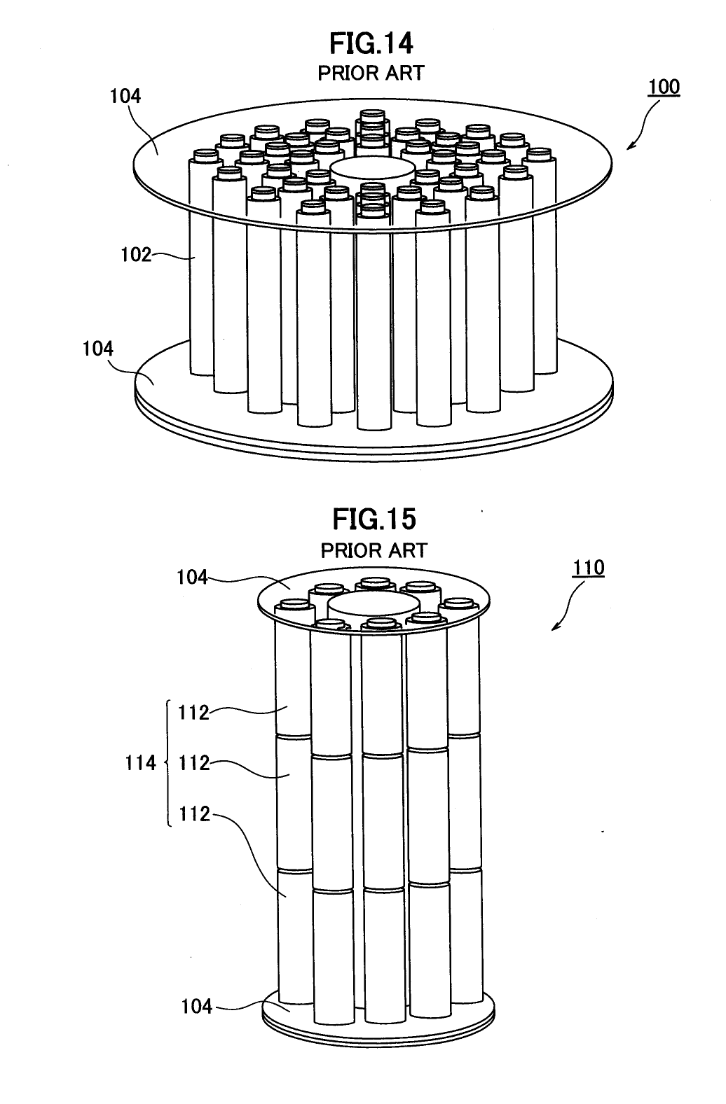

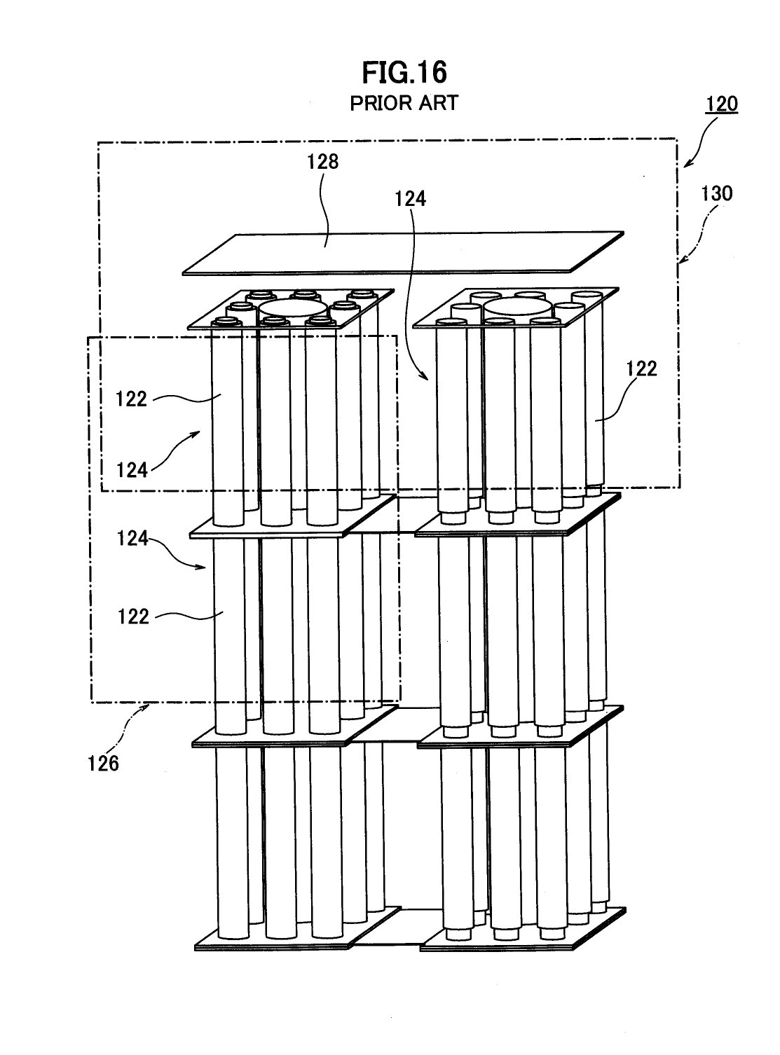

Next, referring to FIG. 13, a third embodiment of the fuel cell device according to the present invention will be explained. FIG. 13 is a schematically plan view thereof.

As shown in FIG. 13, five tubular fuel cell bodies having a peripheral surface and laterally arranged in a fuel cell device 80 which is the third embodiment of the present invention are obtained by replacing the five fuel cells 6-10 in the fuel cell device 1 according to the first embodiment of the present invention with five fuel cell bodies 81, in each of which two fuel cells are arranged in the longitudinal direction A and electrically connected in a series.

Now, these fuel cell bodies 81 will be explained.

Each of the fuel cell bodies 81 has two fuel cells 82, 84 coupled to each other in the longitudinal direction A and electrically connected to each other in a series, and a coupling member 86 coupling one (referred to other later) end 82b of the fuel cell 82 and one end 84a of the fuel cell 84. Since each of the fuel cells 82, 84 has the same components as those in the fuel cell 6 in the fuel cell device 1 according to the first embodiment of the present invention, the components of the fuel cells 82, 84 are indicated by the same reference numbers as those of the components in the fuel cell 6 and explanations of the former components are omitted. It should be noted that the other end 82b of the fuel cell 82 corresponds to the other end 6b of the fuel cell 6 and the one end 84a of the fuel cell 84 corresponds to the one end 6a of the fuel cell 6.

The coupling member 86 is tubular and disposed so that it encloses the other end 82b of the fuel cell 82 and the one end 84a of the fuel cell 84. The coupling member 86 has a annular protrusion 88 in the middle thereof in the longitudinal direction A. The other end 82b of the fuel cell 82 abuts to the protrusion 88 via an insulating body 90 and the one end 84a of the fuel cell 84 also abuts to the protrusion 88. The coupling member 86 is formed of conductive material, and gaps between the fuel cells 82, 84 and the coupling member 86 are sealed with a conductive sealer 92 to make a passage for gas acting on the inner electrode layer 16. The coupling member 86 is made of, for example, heat-resistant metal such as stainless steel, nickel base alloy and chromium base alloy, or ceramics such as lanthanum chromite. The sealer 92 is formed of silver, a mixture of silver and glass, or wax material including silver, gold, nickel, copper, titanium and so on.

The embodiment of the present invention has been explained, but the present invention is not limited to the above-mentioned embodiment and it is apparent that the embodiment can be changed within the scope of the present invention set forth in the claims.

Although, in the above-stated embodiments, the inner electrode layer 16 defines a fuel electrode while the outer electrode layer 20 defines an air electrode, conversely, a fuel cell device may be formed so that the inner electrode layer 16 may be an air electrode while the outer electrode layer 20 may be a fuel electrode. In this case, if gas acting on the inner electrode layer 16 is oxidation gas such as air, the connecting member 40 may be disposed on the third-chamber 26 side for restriction of oxidation degradation of the connecting member 40.

Although, in the above-stated embodiments, the inner electrode exposed periphery 16a and the electrolyte exposed periphery 18a completely extend over the entire circumference thereof, they may not, as long as electricity can be taken out from the peripheral surface of the fuel cell.

The outer electrode peripheral surface 22 means a peripheral surface of the fuel cell 6 electrically communicating with the outer electrode 20 and thus it may be defined by the outer electrode 20 exposed to outside of the peripheral surface of the fuel cell 6 like in the above-stated first embodiment of the fuel cell device, or the outer electrode collecting layer 44a, 44b exposed to outside of the peripheral surface of the fuel cell 6 like in the above-stated variant of the other end of the fuel cell in the first embodiment of the fuel cell device.

Further, an inner electrode collecting layer similar to the outer electrode collecting layer may be provided entirely or partially around the inner electrode layer 16 of the fuel cell 6. For example, such an inner electrode collecting layer may be provided inside of the inner electrode layer 16 or outside of the inner electrode exposed periphery. In the latter case, the inner electrode peripheral surface 21 electrically communicating with the inner electrode layer 16 is defined by the inner electrode collecting layer.

Further, the fuel cell body 81 in the above-stated third embodiment of the fuel cell device may have more than two fuel cells coupled to each other.

Further, in the above-stated embodiments, the fuel cell is a cylindrical tube with a circular cross section, but it may be another cross-sectional form as long as it is tubular. Concretely, the fuel cell may be in a flat-tube form having an oblong or oval cross section or in a polyangular-tube form having a polyangular section.

Further, the above-stated embodiments and variants can appropriately be combined within the scope of the present invention.

What is claimed is:

1. A fuel cell stack incorporated in a fuel cell device comprising:
a plurality of tubular fuel cell bodies arranged laterally relative to a longitudinal direction of the fuel cell bodies; and
electrically insulating support plates fixed to respective opposite ends of the plurality of the fuel cell bodies;
wherein each of the fuel cell bodies has a tubular outer electrode layer, a tubular inner electrode layer and a tubular electrolyte layer disposed between the inner and outer electrode layers;
wherein each of the fuel cell bodies has, at one end thereof, an inner electrode exposed periphery where the inner electrode layer is exposed out of the electrolyte layer and the outer electrode layer;
wherein each of the fuel cell bodies has, on a peripheral surface at the one end thereof, an inner electrode peripheral surface electrically communicating with the inner electrode layer via the inner electrode exposed periphery, and, on a peripheral surface at the other end thereof, an outer electrode peripheral surface electrically communicating with the outer electrode layer;
further comprising connections disposed at each of the support plates to electrically connect the inner electrode peripheral surface(s) to the outer electrode peripheral surface(s) of the fuel cell bodies arranged adjacent to each other in an arbitrary combination.

2. The fuel cell stack according to claim 1, wherein the connections have conductive sealers for sealingly fixing the ends of the fuel cell bodies to the support plate.

3. The fuel cell stack according to claim 1, wherein at least some of the fuel cell bodies are electrically connected in a series.

4. The fuel cell stack according to claim 1, wherein each of the fuel cell bodies is defined by a single fuel cell or a plurality of fuel cells longitudinally coupled to each other and electrically connected to each other in a series.

5. The fuel cell stack according to claim 1, wherein the inner electrode peripheral surface is defined by the inner electrode exposed periphery.

6. The fuel cell stack according to claim 1, wherein the outer electrode peripheral surface is defined by the outer electrode layer.

7. The fuel cell stack according to claim 1, wherein each of the fuel cell bodies further has an outer electrode collecting layer disposed outside of the outer electrode layer, and the outer electrode peripheral surface is defined by the outer electrode collecting layer.

8. A fuel cell device comprising the fuel cell stack according to claim 1.

9. The fuel cell stack according to claim 2, wherein at least some of the fuel cell bodies are electrically connected in a series.

10. The fuel cell stack according to claim 2, wherein each of the fuel cell bodies is defined by a single fuel cell or a plurality of fuel cells longitudinally coupled to each other and electrically connected to each other in a series.

11. The fuel cell stack according to claim 2, wherein the inner electrode peripheral surface is defined by the inner electrode exposed periphery.

12. The fuel cell stack according to claim 2, wherein the outer electrode peripheral surface is defined by the outer electrode layer.

13. The fuel cell stack according to claim 2, wherein each of the fuel cell bodies further has an outer electrode collecting layer disposed outside of the outer electrode layer, and the outer electrode peripheral surface is defined by the outer electrode collecting layer.

14. A fuel cell device comprising the fuel cell stack according to claim 2.

15. The fuel cell stack according to claim 9, wherein each of the fuel cell bodies is defined by a single fuel cell or a plurality of fuel cells longitudinally coupled to each other and electrically connected to each other in a series.

16. The fuel cell stack according to claim 9, wherein the inner electrode peripheral surface is defined by the inner electrode exposed periphery.

17. The fuel cell stack according to claim 9, wherein the outer electrode peripheral surface is defined by the outer electrode layer.

18. The fuel cell stack according to claim 9, wherein each of the fuel cell bodies further has an outer electrode collecting layer disposed outside of the outer electrode layer, and the outer electrode peripheral surface is defined by the outer electrode collecting layer.

19. A fuel cell device comprising the fuel cell stack according to claim 9.
